(19) United States
(12) Patent Application Publication
(10) Pub. No.: US 2004/0139043 A1
(43) Pub. Date: Jul. 15, 2004

(54) Attribute relevant access control policies

(75) Inventors: Chon Hei Lei, Alameda, CA (US); Daniel Man Hung Wong, Sacramento, CA (US); Thomas Keefe, South San Francisco, CA (US)

Correspondence Address: HICKMAN PALERMO TRUONG & BECKER, LLP, 1600 WILLOW STREET, SAN JOSE, CA, 95125, US

(73) Assignee: ORACLE INTERNATIONAL CORPORATION, REDWOOD SHORES, CA

(21) Appl. No.: 10/341,797

(22) Filed: Jan. 13, 2003

(51) Int. Cl. G06F 7/00

(52) U.S. Cl. 707/1

(57) ABSTRACT

A method and apparatus for attribute relevant access control policies is provided. According to one embodiment, a determination is made as to whether to modify a query based on which attributes of a database object are referenced in the query. Further, if the query references one or more attributes of the database object that are restricted, the query may be modified based on attribute restriction metadata. According to another embodiment, users are restricted from accessing data from the restricted attributes by masking the data before returning it to the users. According to yet another embodiment, certain data from restricted attributes may be masked before returning it to users while other data from restricted attributes may be returned without modification.

### RELATED APPLICATION AND PATENT

This application is related to U.S. Pat. No. 6,487,552 B1, issued Nov. 26, 2002, entitled “Database Fine-Grained Access Control”, naming as inventors Chon Hei Lei and Douglass James McMahon, the entire disclosure of which is hereby incorporated by reference. This application is related to U.S. application Ser. No. 09/589,602, filed Jun. 7, 2000, entitled “Partitioned Access Control to a Database”, naming as inventors Daniel ManHung Wong and Chon Hei Lei, the entire disclosure of which is hereby incorporated by reference.

### FIELD OF THE INVENTION

The present invention relates to databases and, more particular, to controlling access to information within a database.

### BACKGROUND OF THE INVENTION

Data, in a database, is stored in one or more data containers, each container contains records, and the data within each record is organized into one or more fields. In relational database systems, the data containers are referred to as tables, the records are referred to as rows, and the fields are referred to as columns. In object oriented databases, the data containers are referred to as database objects, the records are referred to as objects, and the fields are referred to as attributes. Other database architectures may use other terminology. Systems that implement the present invention are not limited to any particular type of data container or database architecture.

In many situations, it may be desirable to prevent all users from accessing all of the rows of a particular table. For example, some rows in a table may contain text in English, while other rows contain text in Spanish. In this case, it would be convenient to limit the access of English-speaking users to the rows containing English, and the access of Spanish-speaking users to the rows containing Spanish.

It may also be desirable to restrict access to certain rows for security reasons. For example, certain rows of a table may contain top secret information, other rows may contain secret information, while other rows contain unclassified information. Under these conditions, the rows made available to any given user should be dictated by the security clearance of that user.

Both of the situations described above require row-level filtering of data, and the second situation also requires that the filtering enforce an access-control policy. To enforce row-level access-control policies, a database server must have a mechanism for restricting users to particular subsets of the rows within tables. One technique for implementing row-level access-control policies involves causing all access to a table to be performed indirectly through “views”.

Views offer a convenient way to provide row-level access control when the users fall into a relatively small number of categories. For example, if users are categorized solely on the basis of language and only two languages are supported, then only two views need to be created. However, many access policies require users to be divided into a large number of categories based on multiple criteria. Under these circumstances, the number of views that must be created and maintained makes the view-based approach to policy enforcement impractical.

Another approach to selectively restricting the information that users can see involves a mechanism for dynamically attaching predicates to queries, where the predicates are attached based on a policy. For example, the database system detects that a query is issued against a database object. Prior to executing the query, a policy function associated with the database object is invoked. The policy function creates a modified query by selectively adding zero or more predicates to the query based on a policy associated with the database object. The modified query is then executed. The dynamically-appended-predicate approach is described in detail in U.S. Pat. No. 6,487,552.

The approaches discussed so far restrict the rows from which data is returned, and are therefore collectively referred to hereinafter as “row-level access-control policy approaches”. One characteristic common to these row-level access-control policy approaches is the all-or-nothing nature of the restrictions. Specifically, for any given row of the table, a user is either able to access all of the information, or none of the information.

To illustrate the all-or-nothing nature of row-level access control policy approaches, consider the database table t2 illustrated in FIG. 1. Table t2 holds information about employees of a company. In database table t2, each row 111-117 holds information for a particular employee, and each column holds a particular type of information. Row 111 holds information for an employee named “Chris”. Chris has an employee ID of 056395, is in department J21, has a social security number of 506-93-2456, a salary of 270,230, and is a manager.

A row-level access-control policy approach may be used to allow every department manager to see the rows that correspond to members of their department, and to restrict non-managers to the row that contains their own information. Assuming that Chris is the manager of department J21, and Cheryl and Craig are in Chris' department, the policy specified above would allow Chris to access all of the information in rows 111, 112 and 114, but to prevent Cheryl and Craig from seeing any information from any row except their own. Specifically, Cheryl would be able to see all information from row 112, but no information from rows 111 and 114, while Craig would be able to see all information from row 114, but no information from rows 111 and 112.

Unfortunately, the all-or-nothing nature of row-level access-policy approaches may not be flexible enough to meet the needs of a company. For example, it may be desirable for all employees to have access to the names, employee ids, and department numbers for all other employees, but to only allow employees to have access to their own salaries. However, the salary information for a person may be in the same row as the employee name. Therefore, a row-level policy that permits a user access to the name of an employee necessarily permits that user to access to the salary information of that employee. Conversely, a policy that prevents a user from accessing the salary information of an employee necessarily prevents the user from accessing the name of the employee.

Based on the foregoing, it is clearly desirable to provide a mechanism for implementing access control policies that do not suffer the all-or-nothing limitation of existing row-level access-control policy approaches.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a database table comprising information about employees of a company;

FIG. 2 is a block diagram that illustrates a computer system for controlling access to information within databases; and

FIG. 3 is a block diagram that illustrates a computer system upon which an embodiment of the invention may be implemented.

### DETAILED DESCRIPTION OF THE INVENTION

A method and apparatus for controlling access to information within a database is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional and System Overview

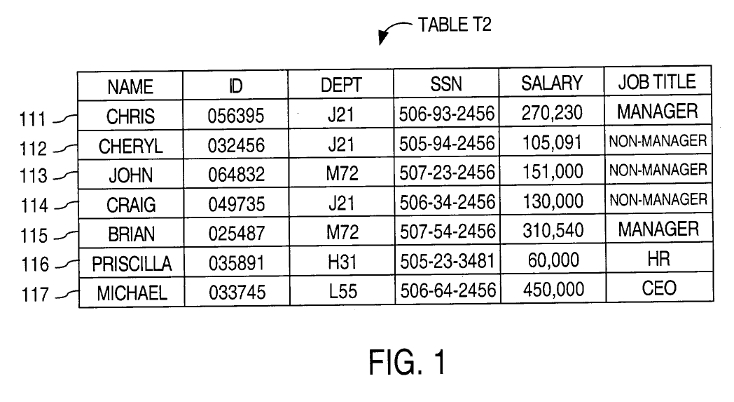

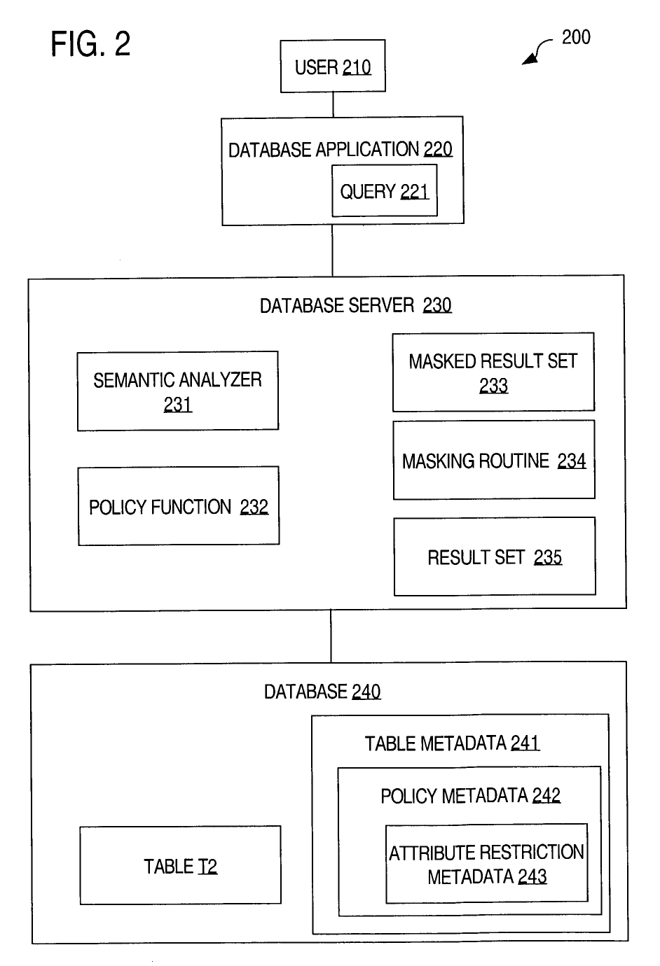

FIG. 2 is a block diagram that illustrates a system 200 for controlling access to information within databases, according to one embodiment. System 200 includes a database application 220 that may be used by a user 210 to request information from a database 240. The database application 220 is designed to issue a query 221 to a database server 230 in response to user interaction. The database server 230 provides the requested information from the table t2 of database 240 to the database application 220. For the purposes of explanation, database 240 is shown with table t2, as depicted in FIG. 1. However, the mechanisms described herein may be used with any database table.

Table t2 is a database object and the columns in table t2 are a set of attributes of the database object. According to one embodiment, a mechanism is provided to support access policies that include attribute-specific restrictions. Such a policy may specify, for example, that one or more attributes of the set of attributes may only be accessed under certain circumstances. Attributes that are subject to such restrictions are referred to hereinafter as “restricted attributes”.

For the purpose of explanation, it shall be assumed that query 221 references one or more of the attributes of table t2. The attributes referenced by query 221 are referred to hereinafter as “referenced attributes”. How database server 230 handles query 221 is determined, in part, based on whether the referenced attributes of query 221 include any restricted attributes of table t2.

According to one embodiment, a determination is made as to whether a query 221 references one or more restricted attributes of a database object. For example, if the query 221 references one or more restricted attributes, then the query 221 may be modified in order to restrict the rows that are returned to the user 210. However, if the query 221 does not reference restricted attributes, then the query 221 is not modified to restrict the rows that are returned to the user, as will be described in more detail.

According to another embodiment, the database server 230 restricts user 210 from seeing data from the restricted attributes without restricting the rows returned to the user. Rather, access to the restricted information is prevented by masking the result set of the query before returning it to the user 210, as will be described in more detail. When masking is used to prevent the user from seeing values for restricted attributes, the masking may be performed selectively, allowing the user to see values for restricted attributes from some rows, and preventing the user from seeing values for restricted attributes from other rows.

Typically, table metadata 241 comprises information describing a database table, such as table t2. For example, table metadata 241 may include data describing the attributes of table t2 and the types of data that may be stored in the table t2.

In the illustrated embodiment, table metadata 241 also includes policy metadata 242 that indicates the access policies that apply to table t2. The policy metadata 242 includes data that indicates what and how information in table t2 is restricted. In particular, the policy metadata 242 includes attribute restriction metadata 243 that indicates which attributes of table t2 are restricted. For example, attribute restriction metadata 243 may indicate that the “SALARY” and “SSN” attributes of table t2 are restricted attributes.

According to one embodiment, the attribute restriction metadata 243 may also include data indicating the manner in which the restricted attributes are restricted. For example, the attribute restriction metadata 243 may indicate that managers may see the salaries of people in their departments while regular employees may only see their own salaries.

According to one embodiment, a semantic analyzer 231 receives the query and determines, based on the policy metadata 242 and an analysis of the query, whether a policy function 232 should be called. For example, the policy metadata 242 may include attribute restriction metadata 243 that indicates which columns of table T2 are restricted. According to one embodiment, the semantic analyzer 231 invokes policy function 232 when the semantic analyzer 231 determines that at least one of the referenced attributes is restricted.

The policy function 232 may be, for example, a user-supplied function that implements user-defined policies. There is virtually no limit to the functionality that may be designed into policy function 232. Consequently, policy function 232 is able to support arbitrarily complex policies. Policy function 232 may be designed, for example, to read user-supplied policy metadata and behave based on the content of that metadata. For the purpose of explanation, an embodiment shall be described in which policy function 232 is designed to determine if and how the query 221 should be modified. According to one embodiment, if policy function 232 determines that query 221 should be modified, then policy function 232 returns a predicate that is appended to query 221 to create a modified query.

For example, assuming that user 210 is “John” and that “SALARY” is a restricted attribute of table t2, when semantic analyzer 231 determines that query 221 attempts to access data from the “SALARY” attribute, semantic analyzer 231 may invoke policy function 232. Policy function 232 may be implemented in such a way as to only allow “John” to access his own salary. In this case, the policy function 232 may return a predicate that is appended to query 221 in order to ensure that the query only retrieves row 113, thus allowing John to see only his own salary, as will be described in more detail.

According to one embodiment, the attribute restriction metadata 243 indicates what values (referred to hereinafter as “masking values”) may be used to mask data from restricted attributes. For example, assuming that “SALARY” is a restricted attribute, if John attempts to access names and salaries for all rows in table t2, John will receive the names from all of the rows but the data from the salary column may be masked with a masking value, such as an integer zero. In this case, when John requests the names and salaries for all of the rows in table t2, the database server 230 retrieves all of the names and salaries from table t2 and stores the unmodified names and salaries in result set 235. The semantic analyzer 231 determines that John is attempting to access a restricted attribute, “SALARY”. The result set 235 is passed to the masking routine 234, which uses the specified masking value, integer zero, to mask the restricted attribute “SALARY”, thus, creating the masked result set 233. The masked result set 233 is provided to the database application 220.

### Modifying a Database Command Prior to Execution when a Database Command References Restricted Attributes

According to one embodiment, a determination is made as to whether to modify a database command prior to execution based on which attributes are referenced. According to one embodiment, if a user requests to access data from attributes that are not restricted, the requested data may be returned to the user without modifying the database command. For example, if NAME and ID are not restricted attributes and John requests to see the names and IDs for all of the people in table t2, then John will be provided the names and IDs for all of the people in table t2.

In another example, assume that “SSN” is a restricted attribute, and a query attempts to access the “SSN” attribute for all rows in table t2. In this case, semantic analyzer 231 determines, based on policy metadata 242, that the “SSN” attribute is restricted, and invokes policy function 232. Policy function 232 then determines whether this query may access the data in the “SSN” attribute. For example, if the query was issued by personnel in human resources, such as Priscilla in row 116, then the policy function 232 may determine that the query does not need to be modified, thus, returning the data from the “SSN” attribute to Priscilla. However, if the query was issued by someone other than personnel in human resources, such as Chris (referring to row 111), the policy function 232 may determine that the query may not access the data in the “SSN” attribute.

According to one embodiment, under these circumstances, the policy function 232 returns a predicate to modify the database command to restrict the rows returned by the database command. For example, a predicate such as “WHERE 1=2”, which always evaluates to false, may be appended to a query, thus, preventing Chris from seeing any data. Alternatively, the policy function 232 may append a predicate to restrict Chris to only the rows that correspond to personnel in Chris' department. For example, a predicate such as “WHERE t.dept=J21” may be appended to the query issued on Chris' behalf.

### Determining Whether to Modify the Database Command Based on the Location of the Attribute in the Database Command

According to one embodiment, the determination of whether to modify the database command is based on where, within the database command, the restricted attribute is referenced. For example, the general syntax of a query is:

SELECT (attribute list)

from (table list)

where (filter list);

The table list indicates the tables from which data is being requested. For example, if the table list includes “employee”, then data is being requested from a table named “employee”.

The attribute list indicates which attributes of the tables the data is being requested from. For example, if the attribute list indicates attributes “NAME” and “DEPT”, then data is being requested from the “NAME” and “DEPT” attributes of table “employee”.

The filter list comprises zero or more predicates for filtering the rows from which to extract data. For example, if the filter list has a predicate “WHERE employee.dept=m72”, then data is being requested from only those rows where the “DEPT” attribute of table “employee” is “m72”.

A query may directly or indirectly access data associated with a column. A query accesses a column directly when the result set of the query includes data from the column. A query accesses a column indirectly when the result set of the query is in some way based on the contents of a column, but does not include data from the column.

Specifying attributes in the attribute list of a database command is an example of accessing data directly, whereas, specifying attributes in a filter list of a database command is an example of accessing data indirectly. For example, if a query contains “NAME” in its attribute list, then the result set of the query includes values from the “NAME” column of the table. However, if the same query does not contain “SALARY” in its attribute list, but does contain “SALARY>$50,000” in its filter list, then the result set of the query will be based on the content of the SALARY column, but will not include values from the SALARY column. In this case, although the user didn't obtain data directly from the salary attribute, the user did obtain information pertaining to salaries.

According to one embodiment, policy function 232 supports policies that treat database commands differently based on where, within the database commands, the restricted attributes appear. For example, a policy function 232 may support the following policies:

(1) if SALARY is in the select list, then restrict the query to the row that contains the information of the user that is submitting the query;

(2) if SALARY is in the filter list, then restrict the query to the rows that contain the information of employees that are in the same department as the user;

(4) if SSN is anywhere in the query and the user is a non-manager, then restrict the query to the row that contains information of the user;

(5) if SSN is in the select list and the user is a manager, then restrict the query to the rows that contain the information from employees that are in the same department as the manager;

(6) if SOCIAL SECURITY is in the filter list and the user is a manager, then do not add any row-level restriction to the query.

According to one embodiment, policies such as these are reflected in the attribute restriction metadata 243. When database server 230 receives the query 221, semantic analyzer 231 determines whether query 221 refers to any restricted attributes, and where any such references occur within the query 221. Based on the attribute restriction metadata 243, semantic analyzer 231 determines whether to call policy function 232, and policy function 232 determines how to modify the query. For example, semantic analyzer 231 may detect that the query references the SSN attribute in the filter list, and that the user is a manager. Based on that determination, semantic analyzer 231 does not call policy function 232. Rather, based on the policy, the query is executed without modification.

### Masking Values

According to one embodiment, masking values are used to mask out data from restricted attributes before returning data to a user. For example, if the attribute restriction metadata 243 indicates that “SSN” is a restricted attribute and that the user who requests the data from the “SSN” attribute is not authorized to access the data, then a masking value, such as “000-000-0000”, may be returned to the user instead of the actual requested social security number.

According to one embodiment, the masking value varies depending on the datatype of the restricted attribute. For example, if the datatype of the restricted attribute is an integer, then the masking value may be an integer zero. Similarly, if the datatype of the restricted attribute is a string, then the masking value may be a string of asterisks.

According to one embodiment, the masking values are configurable. For example, a database administrator may enter data indicating what the masking values are for each of the restricted attributes. An Application Program Interface (API) may be used to configure the masking values. The API may receive the data indicating what the masking values are and store the data in the attribute restriction metadata 243.

In one embodiment, attribute masking may be used in conjunction with row filtering. For example, a policy may specify that if a user submits a query that retrieves salary information, then:

(1) the query is modified to retrieve only rows for employees in the same department as the user;

(2) the SALARY values in the result set are masked in all rows except the row for the user that submitted the query.

Based on those rules, the database server 230 would handle a query that referenced the SALARY attribute as follows: The semantic analyzer 231 would determine that the query references a restricted attribute. Policy function 232 would modify the query to add a predicate that restricts the query to rows that are in the same department as the employee. Once the query is executed, the result set 235 would contain salary information from all of the retrieved rows. A masking routine 234 would then mask the result set 235 to create a masked result set 233 that only contains the salary information for the user that submitted the query. For all other rows in the masked result set, the SALARY column would contain a masking value. The masked result set 233 would then be provided to the database application 220 that submitted the query.

### Operational Examples for Modifying a Database Command Prior to Execution when a Database Command References Restricted Attributes

This section provides descriptions of several scenarios and corresponding operational examples for determining whether a database command references restricted attributes and modifying the database command prior to execution in the event that the database command does reference restricted attributes. For the purposes of explanation, assume that a user of a system, as depicted in FIG. 2, is causing database application 220 to submit a query 221 to access table t2, as depicted in FIG. 1. Further, assume that attribute restriction metadata 243 indicates that “SALARY” and “SSN” are restricted attributes. Additionally, assume that attribute restriction metadata 243 indicates that if an non-managerial employee requests information from the “SALARY” attribute, then the non-managerial employee may only access their own salary information; however, if a manager requests information from the “SALARY” attribute, then the manager may access salaries for people who are in the manager's department but not for people who are outside of the manager's department.

Scenario 1: Someone requests data from an unrestricted attribute. For example, John enters a query requesting to see all of the names and IDs for all people in table t2. In this case, user 210 is John who uses the database application 220 to issue a query 221, which comprises a query as depicted in Q1 below:

Q1:

SELECT name, id

FROM t2

In operational example 1 for scenario 1, database server 230 intercepts query 221. The semantic analyzer 231 obtains the list of restricted attributes (e.g., “SALARY” and “SSN”) from the attribute restriction metadata 243. Semantic analyzer 231 scans query 221 and compares the restricted attributes to the attributes referenced in query 221. In this case, “NAME” and “ID” are the attributes referenced in query 221 and these referenced attributes are not restricted attributes. Therefore, the semantic analyzer 231 does not invoke the policy function 232 and the database server 230 returns the data for attributes “NAME” and “ID” from all of the rows 111-117 of table t2 to user 210.

Scenario 2: An employee who is not a manager requests data from a restricted attribute. For example, John enters a query requesting to see all of the names and salaries for all people. In this case, user 210 is John who uses the database application 220 to issue a query 221, which comprises a query as depicted in Q2 below:

Q2:

SELECT name, salary

FROM t2

In operational example 2 for scenario 2, query 221 references the attributes “NAME” and “SALARY”. In comparing the referenced attributes to the restricted attributes, the semantic analyzer 231 determines that “SALARY” is a restricted attribute. Therefore, the semantic analyzer 231 invokes the policy function 232, which implements the policy that non-managerial employees can only access their own salary information. The policy function 232 generates a predicate to modify query 221 to restrict John to only accessing his own salary information by appending a predicate “WHERE t.id=064832”, which filters on John's employee id, to query 221. Thus, the name, “JOHN” and the salary “$151,000” are returned in response to the query 221.

Scenario 3: An employee who is a manager requests data from a restricted attribute. For example, just as John entered query Q2, Brian, who is a manger of department M72, also enters query Q2 requesting to see all of the salaries for all people. In this case, user 210 is Brian who uses the database application 220 to issue a query 221, which comprises a query as depicted in Q2.

In operational example 3 for scenario 3, the semantic analyzer 231 determines that query 221 references an attribute, “SALARY”, that is designated as a restricted attribute. Semantic analyzer 231 invokes policy function 232, which generates a predicate, “WHERE t.dept=‘M72’”. The predicate is appended to query 221 so that only information for the rows that represent the people in Brian's department is returned in response to query 221.

Both operational examples 2 and 3 use the same query Q2, however, different results are returned to John and Brian because of the policy information stored in the attribute restriction metadata 243. Thus, a database application 220 does not need to be modified in order to provide different results in response to different users.

### Operational Examples For Masking Data from Restricted Attributes

The operational examples in this section use the same assumptions and the same scenarios that were described in the previous section. However, further assume that masking values have been designated for the restricted attributes. For example, a database administrator may designate that an integer zero is used as the masking value for the restricted attribute “SALARY” and that the string “000-000-0000” is used as the masking value for the restricted attribute “SSN”.

In operational example 4 for scenario 1, the database server 235 obtains data for the “NAME” and “ID” attributes for all of the rows 111-117 of table t2 and stores this data in the result set 235. The semantic analyzer 231 determines that query 221, as depicted in Q1, does not reference any attributes that are designated as restricted attributes, thus, the result set 235 is provided to the user 210 unmodified.

In operational example 5 for scenario 2, database server 235 obtains data for the “NAME” and “ID” attributes for all of the rows 111-117 of table t2 and stores this data in the result set 235. The semantic analyzer 231 determines that query 221, as depicted in Q2, does reference an attribute (e.g., “SALARY”) that is designated as a restricted attribute. The masking routine 234 obtains masking values from attribute restriction metadata 243, replaces the data from the “SALARY” attribute with the masking value, integer zero. The modified data is stored in masked result set 233. The masked result set 233 would contain data as depicted below in Table 1.

TABLE 1

| NAME | SALARY |
|---|---|
| CHRIS | 0 |
| CHERYL | 0 |
| JOHN | 0 |
| CRAIG | 0 |
| BRIAN | 0 |
| PRISCILLA | 0 |
| MICHAEL | 0 |

The masked result set 233, as depicted in Table 1, is then provided to user 210.

In operational example 6 for scenario 3, the semantic analyzer 231 would similarly determine that query Q2 references an attribute (e.g., “SALARY”) that is designated as a restricted attribute. The database server 230 would return the same data, as depicted in Table 1, to Brian that it would have returned to John in operational example 5.

According to one embodiment, data from restricted attributes are not always masked. In this embodiment, data in the attribute restriction metadata 243 may indicate that data for certain restricted attributes should be masked under certain circumstances and not masked under other circumstances. For example, the attribute restriction metadata 243 may indicate that a manager may not access salary information for people who are not in their departments but may access the salary information for people in their departments. Further assume, that the attribute restriction metadata 243 indicates that human resources personal can access social security numbers for any one while employees outside of human resources can only access their own social security number. In this case, assume that user 210 is Chris who issues a query 221 comprising the following:

Q3:

SELECT name, salary, ssn

FROM t2

In this case, Chris would receive information that includes the following:

TABLE 2

| NAME | SSN | SALARY |
|---|---|---|
| CHRIS | 506-93-2456 | 270,230 |
| CHERYL | 000-000-0000 | 105,091 |
| JOHN | 000-000-0000 | 0 |
| CRAIG | 000-000-0000 | 130,000 |
| BRIAN | 000-000-0000 | 0 |
| PRISCILLA | 000-000-0000 | 0 |
| MICHAEL | 000-000-0000 | 0 |

### CONCLUSION

The architecture and processes described herein provide mechanisms for implementing access control policies within a database, where the mechanisms (1) do not severely impact the efficiency of query execution, (2) do not rely on users to access data through a particular view or set variables to the appropriate values, (3) support relatively complex access control rules, (4) do not make access control management impracticably complex, (5) can be used to restrict the attributes or columns that data may be returned from, and (6) can be used to return different results in response to different users without modifying a database application. Further, the mechanisms described herein are not limited to attributes and/or columns but may be used for any database command that references any type of feature associated with a database object.

### Hardware Overview

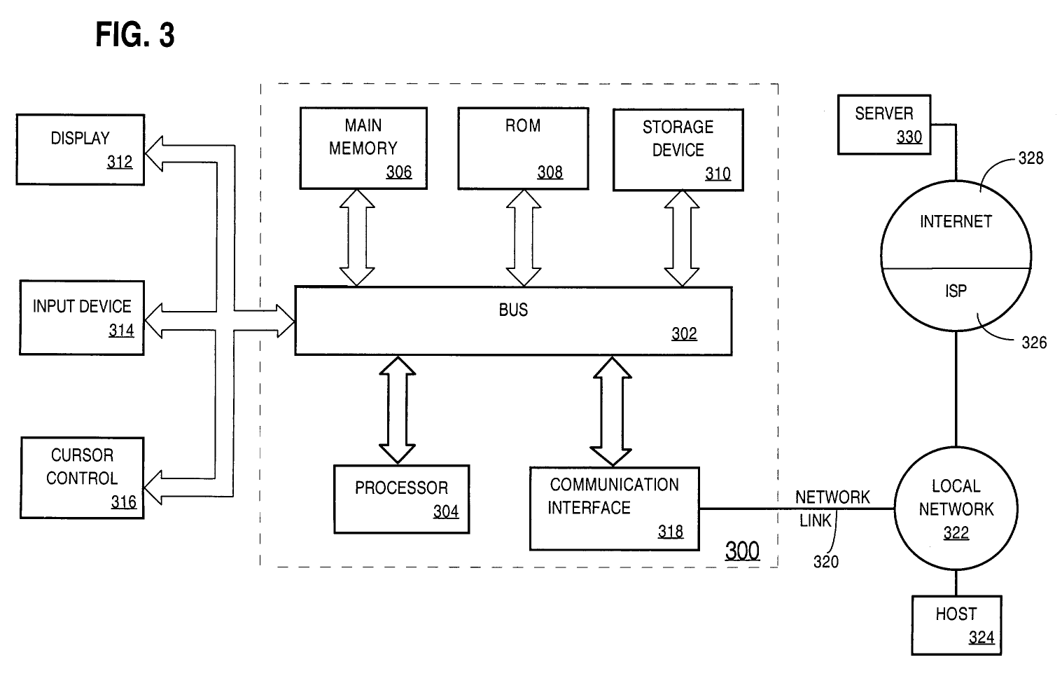

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for executing database commands, comprising the computer-implemented steps of:
receiving a database command that references a set of attributes of a database object;
determining which attributes of the set of attributes are referenced in the database command; and
based on which of the attributes are referenced, determining whether to modify the database command prior to executing the database command.

2. The method of claim 1, wherein the step of determining whether to modify the database command includes the step of determining whether the database command references a restricted attribute.

3. The method of claim 2, wherein the step of determining whether to modify the database command includes the step of determining whether to modify the database command based on where within the database command the restricted attribute is referenced.

4. The method of claim 2, wherein the step of determining whether to modify the database command further comprises the step of determining whether to modify the database command based on whether the restricted attribute is in a select list of the database command.

5. The method of claim 2, wherein the step of determining whether to modify the database command further comprises the step of determining whether to modify the database command based on whether the restricted attribute is in a filter list of the database command.

6. The method of claim 1 further comprising the step of in response to determining whether to modify the database command, modifying the database command.

7. The method of claim 6, wherein the step of modifying the database command, further comprises the step of adding one or more predicates to the database command based on attribute restriction metadata.

8. The method of claim 1, further comprising the step of receiving data that indicates which attributes of the set of attributes are restricted.

9. The method of claim 8, wherein the step of receiving the data further includes the step of using an Application Program Interface (API) to receive the data.

10. The method of claim 1, wherein the step of determining whether to modify the database command includes the step of comparing one or more restricted attributes to one or more referenced attributes to determine which of the one or more referenced attributes are restricted.

11. The method of claim 1, wherein the database object is a table and the attributes of the database object are columns in the table.

12. A method for executing database commands, comprising the computer-implemented steps of:
receiving a database command that references a set of attributes of a database object;
determining which attributes in the set of attributes are restricted; and
generating a result set;
wherein the result set includes a set of rows;
wherein each row in the set of rows includes values for each attribute of the set of attributes;
wherein, for at least one row of the set of rows, values for restricted attributes in the set of attributes are not values from the database object.

13. The method of claim 12 wherein, for all rows of the set of rows, the values for the restricted attributes are masked.

14. The method of claim 12 wherein, at least one row of the set of rows comprises an unmasked value for at least one of the restricted attributes.

15. The method of claim 12 wherein the step of determining which attributes in the set of attributes are restricted, further comprises the step of determining which attributes in the set of attributes are restricted based on attribute restriction metadata.

16. The method of claim 12, further comprising the step of receiving data that indicates which attributes of the set of attributes are restricted.

17. The method of claim 16, wherein the step of receiving the data further includes the step of using an Application Program Interface (API) to receive the data.

18. The method of claim 12, wherein the step of determining which attributes in the set of attributes are restricted further includes the step of comparing one or more restricted attributes to one or more referenced attributes to determine which of the one or more referenced attributes are restricted.

19. The method of claim 12, wherein the database object is a table and the attributes of the database object are columns in the table.

20. A computer-readable medium carrying one or more sequences of instructions which, when executed by one or more processors, causes the one or more processors to perform the method recited in any one of claims 1-19.
